(19) United States
(12) Patent Application Publication
(10) Pub. No.: US 2013/0258112 A1
(43) Pub. Date: Oct. 3, 2013

(54) VISIBLE LIGHT AND IR HYBRID DIGITAL CAMERA

(71) Applicant: Pinchas Baksht, Jerusalem (IL)

(72) Inventor: Pinchas Baksht, Jerusalem (IL)

(73) Assignee: ZAMIR RECOGNITION SYSTEMS LTD., Jerusalem (IL)

(21) Appl. No.: 13/989,819

(22) PCT Filed: Dec. 21, 2011
(86) PCT No.: PCT/IB2011/055855

§ 371 Date: May 28, 2013

Related U.S. Application Data
(60) Provisional application No. 61/425,257, filed on Dec. 21, 2010.

(51) Int. Cl. H04N 5/33; H04N 9/04

(52) U.S. Cl. CPC H04N 5/33; H04N 9/045
USPC 348/164

(57) ABSTRACT

A hybrid camera includes a sensor array, a rolling shutter configured to expose groups of pixels of the sensor array sequentially, an IR illuminator configured to illuminate a scene alternately in synchrony with the rolling shutter and the sensor array, and a control system configured to operate the sensor array, the rolling shutter and the IR illuminator. The hybrid camera control system is configured further to receive raw pixel data from the sensor array that include alternating visible data and visible plus IR data and to create from the raw pixel data a visible image of a scene and a separate monochrome IR image of the scene. An image acquisition method includes illuminating a scene with an IR illuminator alternately in synchrony with a rolling shutter and a sensor array, capturing visible data and visible plus IR data alternately, and creating visible and separate IR images using the captured data.

### FIELD OF THE INVENTION

The present invention relates to digital cameras and, more particularly, to a hybrid visible light and IR digital cameras.

### BACKGROUND OF THE INVENTION

Most of the digital color images captured today use Bayer pattern of red, green and blue (RGB) color filter array (CFA). Alternative color filter arrays like CYGM, RGBE or other panchromatic cells and patterns may have some advantageous but are less often used. FIG. 1 shows a typical prior art Bayer pattern color filter array. A pattern of 3 colors; red (R), green (G) and blue (B) is shown where typically the basic cell is a 2 by 2 pixels array, having two green pixels (110 and 120), a red pixel (130) and a blue pixel (140).

Infrared light (IR) lies between the visible and microwave portions of the electromagnetic spectrum. Infrared light has a range of wavelengths, just like visible light has wavelengths that range from red light to violet. Near infrared light is closest in wavelength to visible light and far infrared is closer to the microwave region of the electromagnetic spectrum IR images. Near IR (NIR) photography has advantages over visible light photography in some specific applications where information extracted from the IR image may be used to improve the visible image processing. IR illumination is undetected by the human vision system and hence it does not disturb human senses. This advantage may be used in various machine vision applications, security related applications and games.

Image registration is the process of transforming different sets of data into one coordinate system. Data may be multiple photographs, data from different sensors, from different times, or from different viewpoints. Image registration is used in computer vision, medical imaging, military automatic target recognition, and compiling and analyzing images and data from satellites. Registration is necessary in order to be able to compare or integrate the data obtained from these different measurements.

Rolling shutter (also known as line scan) is a method of image acquisition in which each frame is recorded not from a snapshot of a single point in time, but rather by scanning across the frame either vertically or horizontally. In other words, not all parts of the image are recorded at exactly the same time, even though the whole frame is displayed at the same time during playback. This is in contrast with global shutter in which the entire frame is exposed for the same time window. This produces predictable distortions of fast-moving objects or when the sensor captures rapid flashes of light. This method is implemented by rolling (moving) the shutter across the exposed image area instead of exposing the image area all at the same time. The rolling shutter method is used with CMOS (Complementary Metal Oxide Semiconductor) sensors.

CMOS sensor array is an integrated circuit containing an array of pixel sensors, each pixel containing a photodetector and an active amplifier. CMOS sensor arrays are most commonly used in cell phone cameras and web cameras. A typical two-dimensional CMOS sensor array of pixels is organized into rows and columns. Pixels in a given row share reset lines, so that a whole row is reset at a time. The row select lines of each pixel in a row are tied together as well. The outputs of each pixel in any given column are tied together. Since only one row is selected at a given time, no competition for the output line occurs. Further amplifier circuitry is typically on a column basis. CMOS sensor arrays are suited to rolling shutter applications and more generally to applications in which packaging, power management, and on-chip processing are important. CMOS type sensors are widely used, from high-end digital photography down to mobile-phone cameras.

There are a variety of companies that manufacture joint near IR and visual cameras. However, the joint NIR and visual cameras are complex, require dual sensor array and sometimes dual lenses or optical beam splitter and hence are expensive.

It would be highly advantageous to provide a hybrid digital camera that creates visible light and IR images of a scene using one sensor array having pixel to pixel alignment.

### SUMMARY OF THE INVENTION

Embodiments of the present invention disclose a hybrid camera and an image acquisition method. The hybrid camera includes a sensor array, a rolling shutter configured to expose groups of pixels of the sensor array sequentially, an IR illuminator configured to illuminate a scene alternately in synchrony with the rolling shutter and the sensor array, and a control system configured to operate the sensor array, the rolling shutter and the IR illuminator. The hybrid camera control system is configured further to receive raw pixel data from the sensor array that include alternating visible data and visible plus IR data and to create from the raw pixel data a visible image of a scene and a separate monochrome IR image of the scene.

According to a further feature of an embodiment of the present invention, the created visible and separate monochrome IR images of the scene have pixel to pixel alignment.

According to a further feature of an embodiment of the present invention, the sensor array comprises a RGB color filter array.

According to a further feature of an embodiment of the present invention, the hybrid camera control system is configured to create a visible image of the scene and an IR image of the scene and is configured further to create multiple images from the groups of pixels of the array exposed in a sequence. One part of the created images includes visible and IR data and a second part of the created images includes visible data only.

According to a further feature of an embodiment of the present invention, the created visible image of the scene and the created IR image of the scene are created by subtracting the one part of the created images that include visible and IR data and the second part of the created images that include visible data only.

According to a further feature of an embodiment of the present invention, the multiple images are created by estimating pixels not captured from captured pixels.

According to a further feature of an embodiment of the present invention, estimating pixels not captured from captured pixels is performed using an interpolation scheme of the captured pixels.

According to a further feature of an embodiment of the present invention, one part of the created images include a first visible color plus IR image and a second visible color plus IR image, and wherein the second part of the created images include the first visible color image and a third visible color image, and wherein the IR image is created by subtracting the first visible color image from the first visible color with IR image, and the color image is created by the first visible color, second visible color and third visible color images. The second visible color image is further calculated by subtracting the created IR image from the second visible color with IR image.

According to a further feature of an embodiment of the present invention, the first visible color image is calculated using linear and bi-linear interpolation schemes as follows; the captured raw first visible color pixels are located in odd rows and odd columns of a pixels array wherein first, interpolated first visible color pixels are interleaved in the odd rows between each two captured raw first visible color pixels, wherein the interpolated first visible color pixels are calculated as an average of the two adjacent captured raw first visible color pixels, and wherein next the data pixels stored in the odd rows is interpolated to the even rows wherein an average of two adjacent pixels above and below each of said even row's pixels is calculated.

According to a further feature of an embodiment of the present invention, the third visible color image is calculated using linear and bi-linear interpolation schemes as follows; the captured raw third visible color pixels are located in the odd rows and even columns of the pixels array wherein first, interpolated, third visible color pixels are interleaved between the captured raw third visible color pixels of the pixels array, wherein the interpolated third visible color pixels are calculated as an average of the two adjacent captured raw third visible color pixels, and wherein next the data stored in the odd rows is interpolated to the even rows wherein an average of two adjacent pixels above and below each of the even row's pixels is calculated, and wherein row 0 is copied from row 1.

According to a further feature of an embodiment of the present invention, the first visible color with IR image is calculated using linear and bi-linear interpolation schemes as follows; the captured raw first visible color+IR pixels are located in the even rows and columns of the pixels array wherein first, an interpolated first visible color+IR pixels are interleaved between the captured raw first visible color+IR pixels of the pixels array, wherein the interpolated first visible color+IR pixels are calculated as an average of the two adjacent captured raw first visible color+IR pixels, and wherein next the data stored in the even rows is interpolated to the odd rows wherein an average of two adjacent pixels above and below each of the even row's pixels is calculated.

According to a further feature of an embodiment of the present invention, the second visible color with IR image is calculated using linear and bi-linear interpolation schemes as follows; the captured raw second visible color+IR pixels are located in the even rows and odd columns of the pixels array wherein first, interpolated second visible color+IR pixels are interleaved between the captured raw second visible color+IR pixels of the pixels array, wherein the interpolated second visible color+IR pixels are calculated as an average of the two adjacent captured raw second visible color+IR pixels, and wherein next the data stored in the even rows is interpolated to the odd rows wherein an average of two adjacent pixels above and below each of the even row's pixels is calculated, and wherein column 0 is copied from column 1.

According to a further feature of an embodiment of the present invention, the rolling shutter configured to expose groups of pixels of the sensor array in a sequence and IR illuminator configured to illuminate the scene in synchrony with the exposed sequence is selected from the group consisting of: at least portions of odd rows are exposed sequentially to visible light only and at least portions of even rows are exposed to visible and IR illumination, at least portions of even rows are exposed sequentially to visible light only and at least portions of odd rows are exposed to visible and IR illumination, at least portions of odd columns are exposed sequentially to visible light only and at least portions of even columns are exposed to visible and IR illumination, and at least portions of even columns are exposed sequentially to visible light only and at least portions of odd columns are exposed to visible and IR illumination.

According to a further feature of an embodiment of the present invention, the sensor array is a CMOS sensor array.

According to a further feature of an embodiment of the present invention, the IR illuminator is an array of LED's.

According to a further feature of an embodiment of the present invention, the control system processor is selected from the group consisting of: FPGAs, ASICs and embedded processors.

According to a further feature of an embodiment of the present invention, the first visible color is green, second visible color is red and the third visible color is blue.

According to a further feature of an embodiment of the present invention, an image acquisition method is disclosed. The method includes the steps (a) illuminating a scene with an IR illuminator alternately in a sequence and in synchrony with a rolling shutter and a sensor array, (b) capturing the image in a sequence in groups of pixels that include visible data and visible plus IR data alternately using the sensor array, and (c) creating visible and separate monochrome IR images using the captured data and having pixel to pixel alignment.

According to a further feature of an embodiment of the present invention, the method includes further the step of capturing the image in a sequence in groups of pixels using the sensor array comprises further the step of using a RGB color filter.

According to a further feature of an embodiment of the present invention, the method includes further the step of creating visible and separate monochrome IR images of the scene comprises further creating multiple images from the captured groups of pixels, and wherein one part of the multiple created images includes visible and IR data and a second part of the multiple created images includes visible data only.

According to a further feature of an embodiment of the present invention, the step of creating the multiple images comprises further the step of interpolating the captured pixel data.

According to a further feature of an embodiment of the present invention, the step of creating visible and IR images of a scene comprises further subtracting the second part of the created images that include visible data only from the first part of the created images that include visible plus IR data.

According to a further feature of an embodiment of the present invention, the created one part of the multiple images includes a first visible color plus IR image and a second visible color plus IR image, and wherein the second part of the created images includes a first visible color image and a third visible color image, and wherein the step of creating an IR image comprises further the step of subtracting the first visible color image from the first visible color plus IR image, and wherein the step of creating the visible image comprises further the step of subtracting the created IR image from the second visible color plus IR image.

According to a further feature of an embodiment of the present invention, the step of interpolating the captured pixel data is performed using linear and bi-linear interpolation schemes.

According to a further feature of an embodiment of the present invention, the method includes the step of calculating the first visible color image that comprises further the steps of (a) interleaving of interpolated first visible color pixel values in each odd row between the captured raw first visible color pixels, wherein the interpolated first visible color pixels are calculated as an average of the two adjacent captured raw first visible color pixels, and (b) interpolating the captured raw first visible color pixels to the even rows and to all columns by calculating an average of two adjacent pixels above and below each of the pixels.

According to a further feature of an embodiment of the present invention, the method includes the step of calculating the third visible color image that comprises further the steps of (a) interleaving of interpolated third visible color pixel values in each odd row between the captured raw third visible color pixels, wherein the interpolated third visible color pixels are calculated as an average of the two adjacent captured raw third visible color pixels, and (b) interpolating the captured raw third visible color pixels to the even rows to all columns by calculating an average of two adjacent pixels above and below each of the pixels, and wherein row 0 is copied from row 1.

According to a further feature of an embodiment of the present invention, the method includes the step of calculating the first visible color and IR image that comprises further the steps of (a) interleaving of interpolated first visible color+IR pixels values in each even row between the captured raw first visible color+IR pixels, wherein the interpolated first visible color+IR pixels are calculated as an average of the two adjacent captured raw first visible color+IR pixels, and (b) interpolating the captured raw first visible color+IR pixels to the odd rows to all columns by calculating an average of two adjacent pixels above and below each of the pixels.

According to a further feature of an embodiment of the present invention, the method includes the step of calculating the second visible color and IR image that comprises further the steps of (a) interleaving of interpolated second visible color+IR pixel values in each even row between the captured raw second visible color+IR pixels, wherein the interpolated second visible color+IR pixels are calculated as an average of the two adjacent captured raw second visible color+IR pixels, and (b) interpolating the captured raw second visible color+IR pixels to the odd rows to all columns by calculating an average of two adjacent pixels above and below each of the pixels, and wherein column 0 is copied from column 1.

According to a further feature of an embodiment of the present invention, the first visible color is green, second visible color is red and the third visible color is blue.

According to a further feature of an embodiment of the present invention, an automated number plate recognition image acquisition method based on the image acquisition method described herein is further disclosed. The automated number plate recognition image acquisition method captured scenes are car's license plates wherein the method further comprises the steps of reading the car license number from the created monochrome IR image, identifying the color of the car license plate from the created visible color image and transmitting the created cars license plates visible and IR digital images having a pixel to pixel alignment to a computer.

According to a further feature of an embodiment of the present invention, an image acquisition method for machine vision applications based on the image acquisition method is further disclosed. The image acquisition method for machine vision applications comprises further the step of using IR information acquired from the IR images for processing the created visible images.

According to a further feature of an embodiment of the present invention, the IR information acquired from the IR images is used to reduce color variations due to changes in visible illumination sources types and directions in face image processing.

According to a further feature of an embodiment of the present invention, the IR information acquired from the IR images includes distance information.

Additional features and advantages of the invention will become apparent from the following drawings and description.

### BRIEF DESCRIPTION OF THE DRAWINGS

Various embodiments are herein described, by way of example only, with reference to the accompanying drawings, wherein:

FIG. 1 shows a prior art Bayer pattern color filter array (CFA);

FIG. 2 illustrates a hybrid camera with an IR illuminator of the present invention;

FIG. 3 illustrates the image acquisition process of the present invention in a timing diagram;

FIG. 4 illustrates a part of the captured image in a Bayer like pattern of the present invention;

FIGS. 5a-b illustrate the green image creation in a Bayer like pattern and in a flow diagram;

FIGS. 6a-b illustrate the blue image creation in a Bayer like pattern and in a flow diagram;

FIGS. 7a-b illustrate the red+IR image creation in a Bayer like pattern and in a flow diagram;

FIGS. 8a-b illustrate the green+IR image creation in a Bayer like pattern and in a flow diagram;

FIG. 9 illustrates the creation of the visible light image and IR image of the present invention;

FIG. 10 illustrates the hybrid camera download connection to a PC of the present invention;

FIG. 11 illustrates a car license plate captured with the hybrid camera of the present invention and the created visible and IR images;

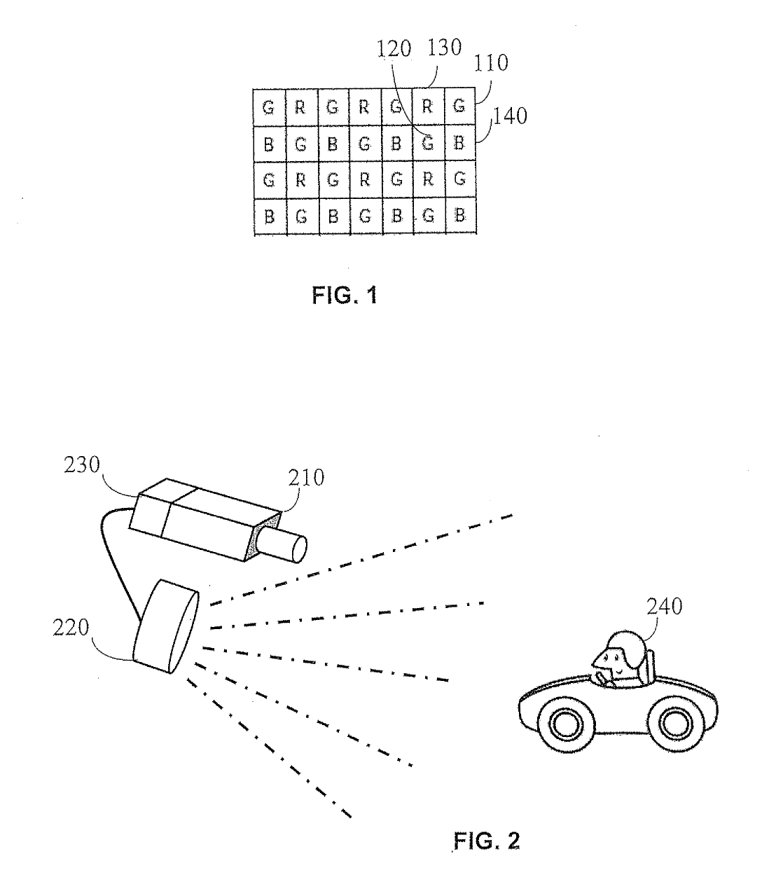

### DESCRIPTION OF THE PREFERRED EMBODIMENTS

The principles and operation of a hybrid camera according to the present invention may be better understood with reference to the drawings and the accompanying description.

According to embodiments of the present invention a hybrid camera includes a sensor array, a rolling shutter configured to expose groups of pixels of the sensor array in a sequence, an IR illuminator configured to illuminate a scene alternately in synchrony with the rolling shutter and sensor array, a control system configured to operate the sensor array, the rolling shutter and the IR illuminator. The hybrid camera control system is configured further to receive raw pixel data from the sensor array that include alternating visible data and visible plus IR data and to combine the data to create a visible image of a scene and an IR image of the scene with a pixel to pixel alignment. According to embodiments of the present invention, the sensor array is a day and night type sensor array that ensures similar sensitivity in IR range for the three colors: red, green and blue.

Returning now to the drawings, FIG. 2 illustrates the hybrid camera according to embodiments of the present invention. A visible light and IR hybrid camera includes a rolling shutter camera 210, an IR illuminator 220 and a timer 230. FIG. 2 illustrates the camera and the IR illuminator in separate housings however in embodiments of the present invention, camera 210 and IR illuminator 220 are placed within the same camera housing. Hybrid camera 220 includes a day and night type sensor array, a rolling shutter configured to expose groups of pixels of the sensor array in a sequence. The IR illuminator 220 is configured to illuminate a scene 240 alternately in synchrony with the rolling shutter and sensor array using timer 230. Camera 220 includes further a control system configured to operate the sensor array, the rolling shutter and the IR illuminator. The control system is configured further to receive raw pixel data from the sensor array that include alternating visible data and visible plus IR data and to combine the data in order to create a visible image of the scene and a separate monochrome IR image of the scene with pixel to pixel alignment.

According to embodiment of the present invention, the IR illuminator may be comprised of light emitting diodes (LEDs) in an array. Other IR sources, that can be switched on and off within microseconds, may be used to illuminate alternately the captured scene and such IR sources are in the scope of the present invention.

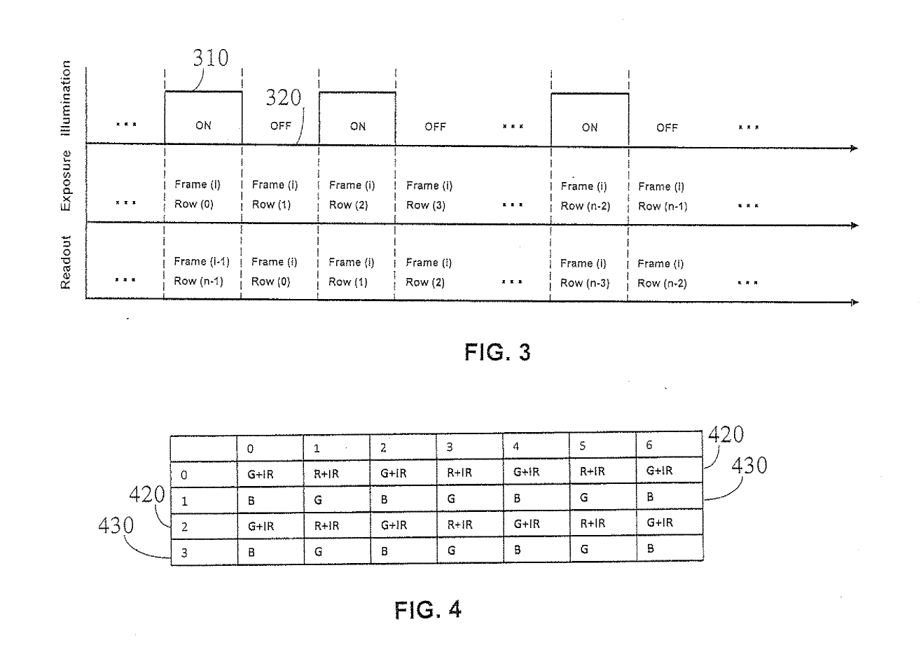

FIG. 3 illustrates the image acquisition process of the present invention in a timing diagram. The IR illuminator illuminates alternately with an on time 310 ranges of 1-100 microseconds, and more typically in the range of 20-30 microseconds. A group of pixels, typically a row of the sensor array, is exposed to the scene with a rolling shutter and capture visible light and the reflected IR illumination. During the off time 320 the IR illuminator is turned off and the next group of pixels, typically the next row of the sensor array, is exposed to the scene with the rolling shutter and capture visible light only. The IR illuminating cycle is repeated in a sequence until all the pixel groups are exposed to the scene and the full image is captured. Note that the IR illumination on time should not be higher than the line readout acquisition time as illustrated in FIG. 3.

According to embodiments of the present invention, the exposure sequence may be for example: odd rows are exposed sequentially to visible light only and even rows are exposed to visible and IR illumination. The exposure sequence may be inverted where even rows are exposed sequentially to visible light only and odd rows are exposed to visible and IR illumination. Alternatively, the exposure sequence may expose odd columns sequentially to visible light only and even columns to visible and IR illumination, or vise versa, even columns are exposed sequentially to visible light only and odd columns are exposed to visible and IR illumination. Other exposure sequences, that expose alternate groups of pixels that may be a portion of a row or a portions of a column for example to visible light+IR and to visible light only, may be used to expose the sensor array alternately as described herein and any such sequence is within the scope of the present invention.

FIG. 4 illustrates a part of the captured image in a Bayer like pattern of the present invention. The present invention preferably uses a Bayer like pattern of RGB color filter array. Accordingly, the even rows 420 include red with IR pixels (R+IR) and green with IR (G+IR) pixels alternately in each row since they are captured when the IR illuminator is turned on. The odd rows 430 include blue pixels (B) and green (G) pixels alternately in each row since they are captured when the IR illuminator turned off.

According to embodiments of the present invention, the CFA of the sensor array may be an RGB filter as illustrated in FIG. 4 in one embodiment and is a non limiting example of a CFA. Other CFAs that have at least one color pixel in all rows may replace the RGB CFA and are in the scope of the present invention.

According to embodiments of the present invention, the hybrid camera control system is configured to create a visible image of a scene and an IR image of the scene. The hybrid camera control system is configured further to create multiple images from the groups of pixels of the sensor array exposed in a sequence, wherein one part of the created images include visible and IR data and a second part of the created images include visible data only. The multiple images includes at least a first visible color image, a first visible color image with IR, a second visible color image with IR and a third visible color image. The multiple images are created using an estimation scheme (typically an interpolation scheme) of the captured groups of raw pixels where all created images have pixel to pixel alignment.

In the description and figures below the first visible color is green, the second visible color is red and the third visible color is blue according to a Bayer RGB pattern. However, other colors may be used and are in the scope of the present invention and the Bayer RGB pattern described herein is given as a non limiting example of a color filter array.

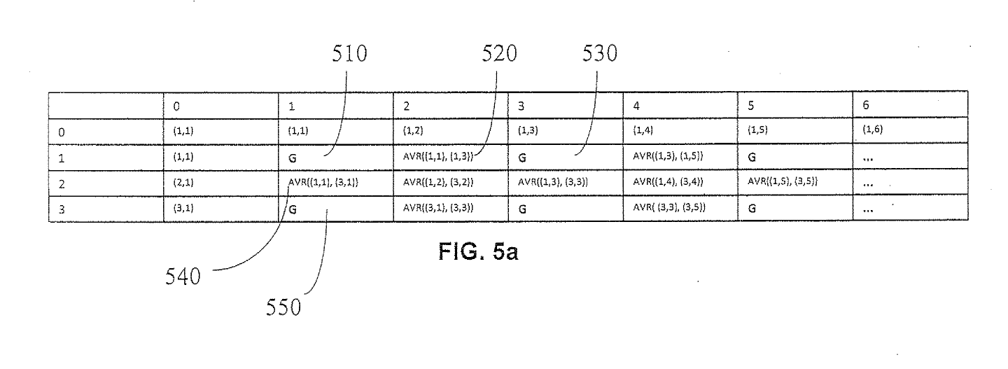

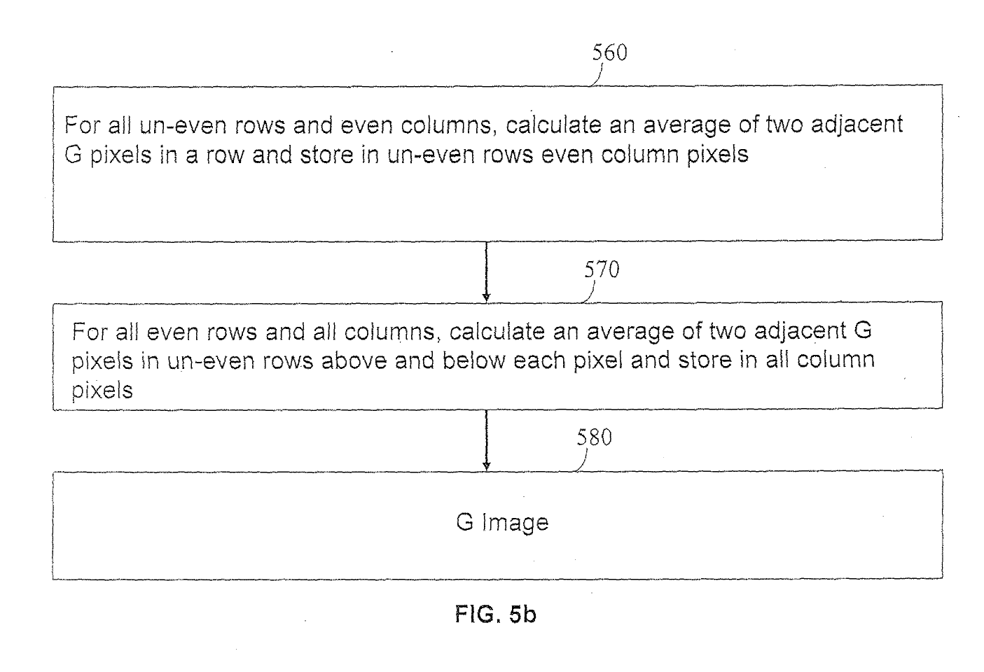

FIGS. 5a-b illustrate the green image creation in a Bayer like pattern and in a flow diagram. The green image is calculated using linear and bi-linear interpolation schemes to estimate pixels not captured from captured pixels as follows: the captured raw G pixels are located in odd rows and odd columns of the sensor array as shown in FIG. 4 hereinabove. FIG. 5a illustrates the green image creation in a Bayer like pattern. First, interpolated G pixels 520 are interleaved in each odd row between the captured raw G pixels 510 and 530, wherein the interpolated G pixels 520 are calculated as an average of their two adjacent captured raw G pixels 510 and 530 in that row. Next, the green image captured and interpolated data pixels of the odd rows are interpolated to the even rows 530 wherein averages of two adjacent pixels 540 and 550 above and below each of the even row's pixels are calculated.

FIG. 5b illustrates the interpolation scheme in a flow chart. In step 560 for all odd rows and even columns, an average of two adjacent G pixels in a row are calculated and stored in odd rows and even column pixels. Next in step 570 for all even rows and all columns, averages of two adjacent G pixels in odd rows above and below each pixel are calculated and stored in all column pixels. Finally, the green image 580 is obtained and stored in the control system memory having a full green image with pixel to pixel alignment with the other created images as described herein below.

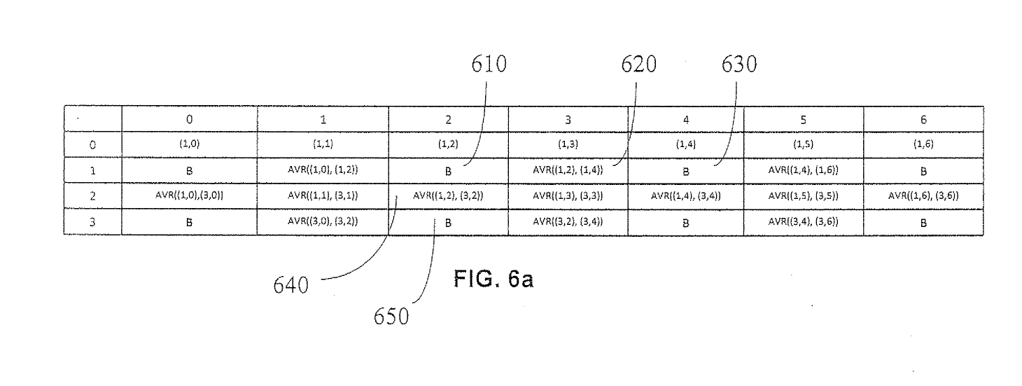

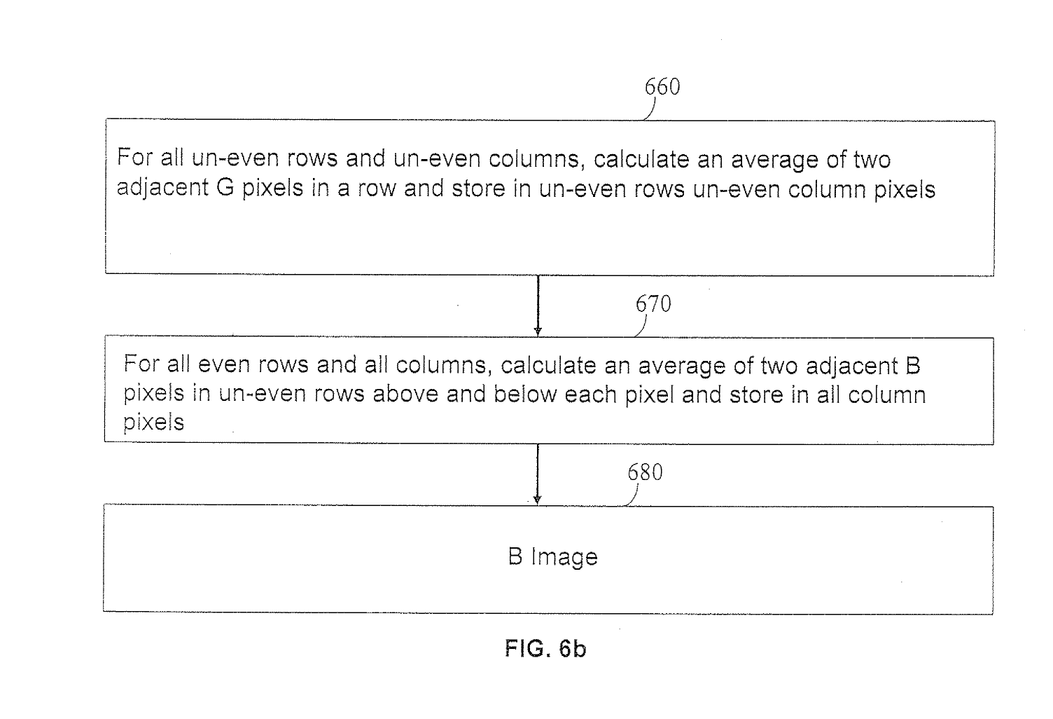

FIGS. 6a-b illustrate the blue image creation in a Bayer like pattern and in a flow diagram. The blue image is calculated using linear and bi-linear interpolation schemes as follows: the captured raw B pixels are located in odd rows and even columns of the sensor array as shown in FIG. 4 hereinabove. FIG. 6a illustrates the blue image creation in a Bayer like pattern. First, interpolated B pixels 620 are interleaved in each odd row between the captured row B pixels 610 and 630, wherein the interpolated B pixels 520 are calculated as an average of their two adjacent captured raw B pixels 610 and 630 in that row. Next, the blue image captured and interpolated data pixels of the odd rows are interpolated to the even rows 630 wherein averages of two adjacent pixels 640 and 650 above and below each of the even row's pixels are calculated.

FIG. 6b illustrates the interpolation scheme in a flow chart. In step 660 for all odd rows and odd columns, an average of two adjacent B pixels in a row are calculated and stored in odd rows odd column pixels. Next in step 670 for all even rows and all columns, averages of two adjacent B pixels in odd rows above and below each pixel are calculated and stored in all column pixels. Finally, the blue image 680 is obtained and stored in the control system memory having a full blue image with pixel to pixel alignment with the green and the other created images.

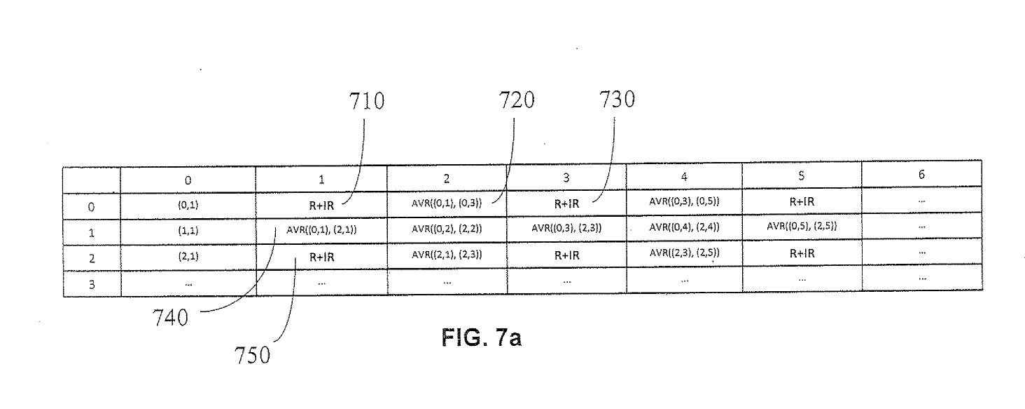

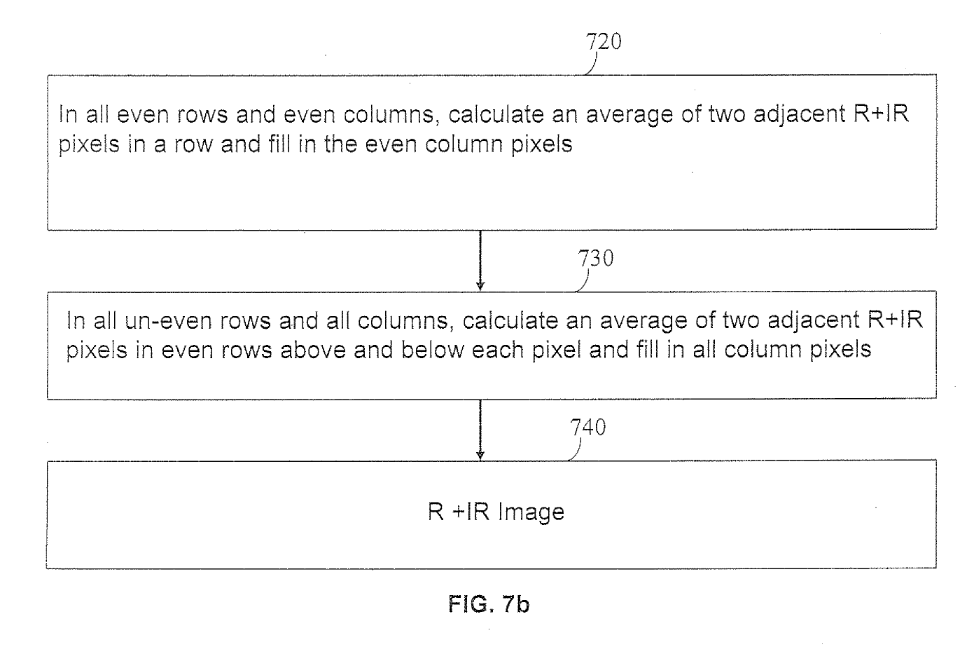

FIGS. 7a-b illustrate the red+IR image creation in a Bayer like pattern and in a flow diagram. The red+IR image is calculated using linear and bi-linear interpolation schemes as follows: the captured raw R+IR pixels are located in even rows and odd columns of the sensor array as shown in FIG. 4 hereinabove. FIG. 7a illustrates the R+IR image creation in a Bayer like pattern. First, interpolated R+IR pixels 720 are interleaved in each even row between the captured raw R+IR pixels 710 and 730, wherein the interpolated R+IR pixels 720 are calculated as an average of their two adjacent captured raw R+IR pixels 710 and 730 in that row. Next, the R+IR image captured and interpolated data pixels of the even rows are interpolated to the odd rows 730 wherein averages of two adjacent pixels 740 and 750 above and below each of the odd row's pixels are calculated.

FIG. 7b illustrates the interpolation scheme in a flow chart. In step 760 for all even rows and odd columns, an average of two adjacent R+IR pixels in a row are calculated and stored in even rows and even column pixels. Next in step 770 for all odd rows and all columns, averages of two adjacent R+IR pixels in even rows above and below each pixel are calculated and stored in all column pixels. Finally, the R+IR image 780 is obtained and stored in the control system memory having a full R+IR image with pixel to pixel alignment with the other created images.

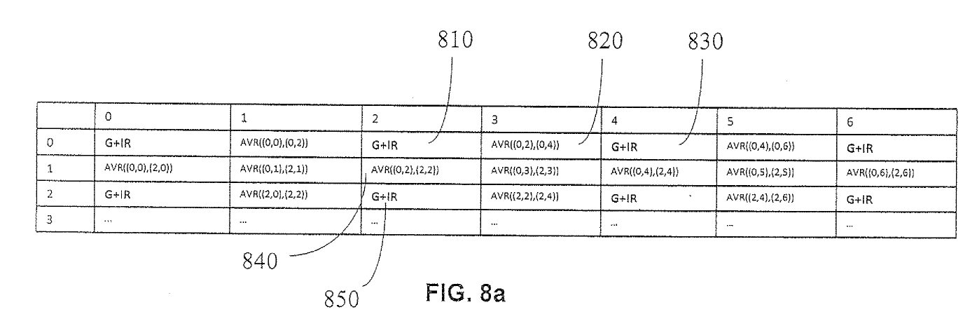

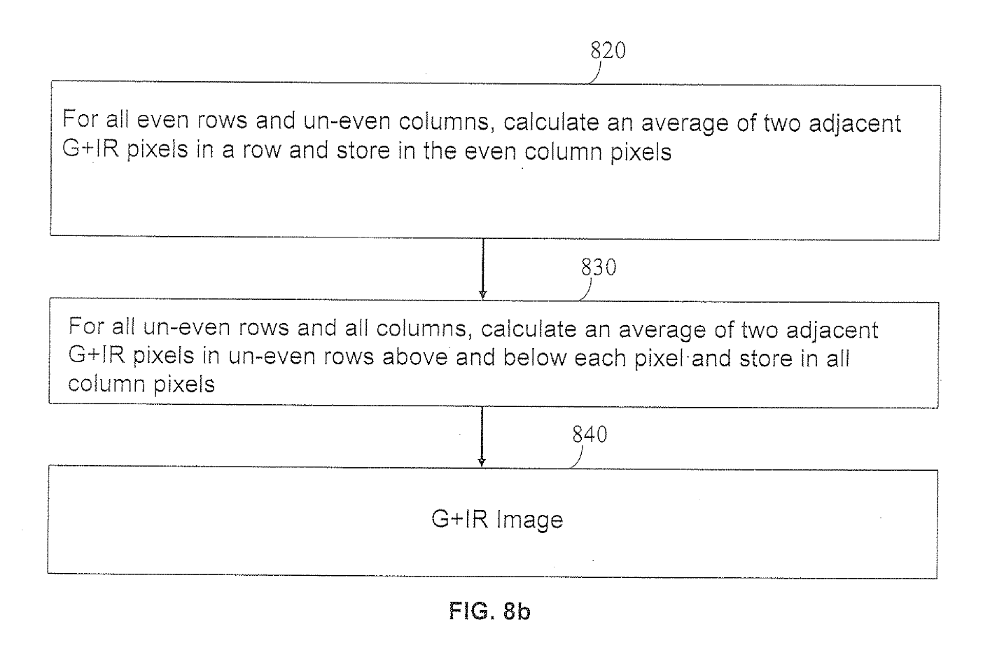

FIGS. 8a-b illustrate the green+IR image creation in a Bayer like pattern and in a flow diagram. The G+IR image is calculated using linear and bi-linear interpolation schemes as follows: the captured raw G+IR pixels are located in even rows and even columns of the sensor array as shown in FIG. 4 hereinabove. FIG. 8a illustrates the G+IR image creation in a Bayer like pattern. First, interpolated R+IR pixels 820 are interleaved in each even row between the captured raw G+IR pixels 810 and 830, wherein the interpolated G+IR pixels 820 are calculated as an average of their two adjacent captured raw G+IR pixels 810 and 830 in that row. Next, the G+IR image captured and interpolated data pixels of the even rows are interpolated to the odd rows 830 wherein averages of two adjacent pixels 840 and 850 above and below each of the odd row's pixels are calculated.

FIG. 8b illustrates the interpolation scheme in a flow chart. In step 860 for all even rows and even columns, an average of two adjacent G+IR pixels in a row are calculated and stored in even rows and odd column pixels. Next in step 870 for all odd rows and all columns, averages of two adjacent G+IR pixels in even rows above and below each pixel are calculated and stored in all column pixels. Finally, the G+IR image 880 is obtained and stored in the control system memory having a full G+IR image with pixel to pixel alignment with the other created images.

According to embodiments of the present invention, the estimation scheme may be an interpolation scheme, such as linear and bi-linear interpolations, gradient base interpolations, high quality interpolations, higher order polynomial interpolations and basis set expansion based interpolations etc. The estimation scheme estimates pixels not captured from captured pixels and such estimating schemes are in the scope of the present invention.

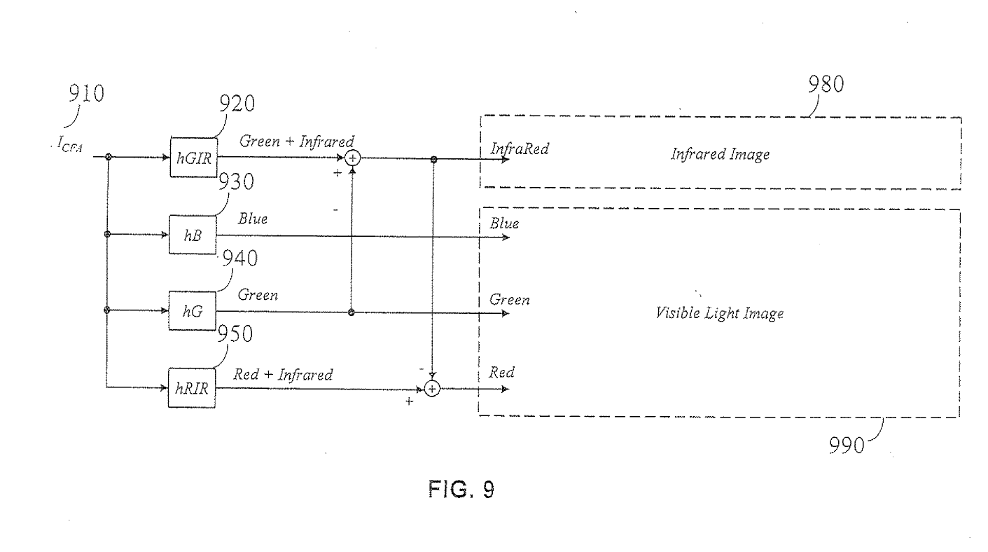

FIG. 9 illustrates the creation process of the visible light image and IR image of the present invention. The hybrid camera control system is configured to subtract the first part of the created images that include visible and IR data and the second part of the created images that include visible data only in order to create a visible image and an IR image with a pixel to pixel alignment. According to embodiments of the present invention, one part of the created images includes green plus IR image and red plus IR image. The second part of the created images includes green image and blue image. The raw data coming from the sensor array CFA 910 (I_{CFA}) is used to create the four images as described hereinabove with references to FIGS. 5-8, i.e. the green+IR image 920, the blue image 930, the green image 940 and the red+IR image 950. The IR image 980 is created by subtracting the green image 940 from the green+IR image 920, and the visible light image 990 is created by the combined green, blue and red images where the red image is calculated by subtracting the created IR image 980 from the red+IR image 940. The IR image 980 and the visible image 990 have a pixel to pixel alignment of the captured scene by design.

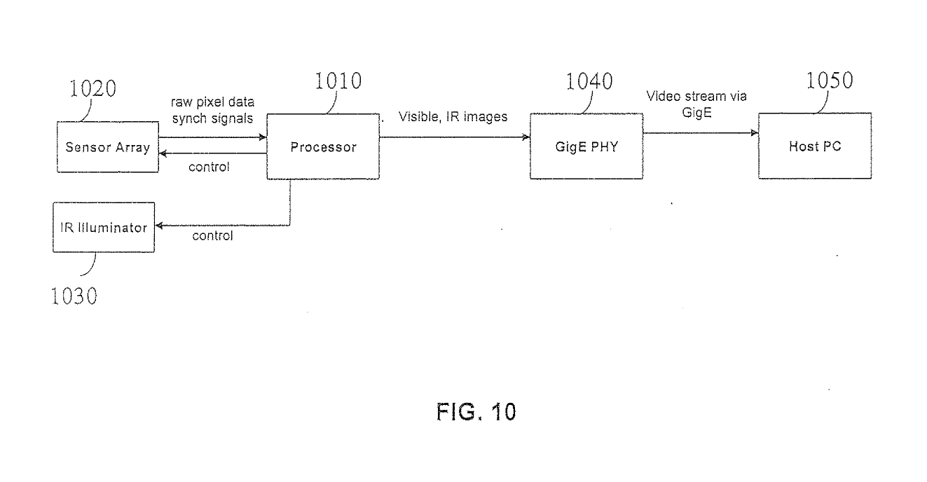

FIG. 10 illustrates the hybrid camera with a download connection to a PC of the present invention. Processor 1010 activates sensor array 1020 and IR illuminator 1030 alternately and receives the captured pixels data in groups in a sequence. Processor 1030 creates the visible and the separate monochrome IR images of the scene with a pixel to pixel alignment and using a GigE PHY communication block 1040 transmits the digital data in a video stream format to a host PC 1050.

According to embodiments of the present invention, an automated number plate recognition (ANPR) system and image acquisition method based on the present invention hybrid camera are provided. Accordingly, the captured scenes, captured by the hybrid camera, illustrated in FIG. 2, may be cars' license plate, where the visible image and the separate monochrome IR image of the captured license plate have pixel to pixel alignment and where the car license number may be acquired from the created monochrome IR image, the color of the car license plate may be acquired from the created visible color image and where both images are transmitted to a computer for further processing as illustrated in FIG. 10.

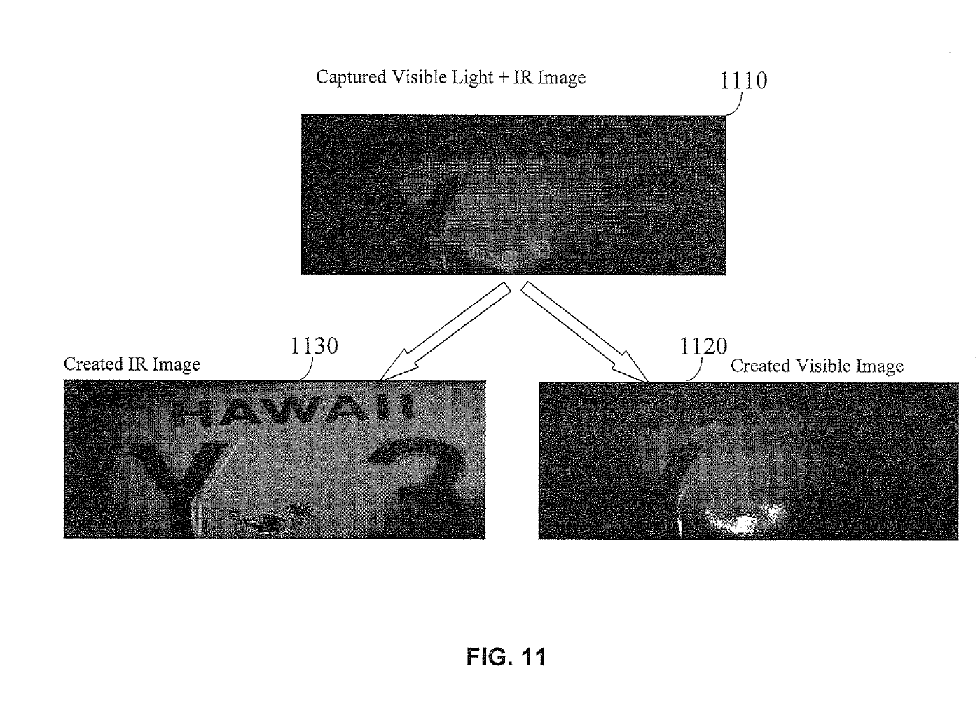

FIG. 11 illustrates a car license plate captured with the hybrid camera of the present invention and the created visible and IR images. A car license plate is captured with visible light and alternating IR illumination 1110. The hybrid camera of the present invention creates a visible color image 1120 and a separate monochrome IR image 1130. The monochrome IR image 1130 has a better contrast and the license plate number can be read easily. The color information is included in the created visible image 1120 while the original captured license plate image 1110 is dark and it is hard to identify the license plate information from it. As shown in FIG. 11, the present invention hybrid camera may make the license plate number easier to read in varied lighting scenarios in outdoor applications.

According to embodiments of the present invention, the alternating IR illumination of the hybrid camera is not sensed by the human vision system and hence it does not disturb the captured objects. IR information helps to reduce color variations due to changes in visible illumination source types and directions in face image processing. IR information provides useful signatures of the face that is insensitive to ambient lighting through the measurement of heat energy radiated from the object and seen with near IR. Accordingly, embodiments of the present invention hybrid camera may be used to reduce color variations in face image processing taking advantage of the pixel to pixel alignment of the created visible face images and the created IR images.

IR information may be used to measure accurately distances from object surfaces using structured light sequences. According to embodiments of the present invention, the hybrid camera may be used to measure distances from the captured scene surfaces and the distance information may be used in machine vision applications such as face recognition applications as one non-limiting example.

According to embodiments of the present invention, the hybrid camera created visible and IR images may be used to improve image processing in various machine vision applications in defense and military applications, medical device applications, automated packaging, security, surveillance and homeland applications, recycling and rubbish sorting, inspection, traffic, pharmaceutical and video games.

Advantageously, the present invention hybrid camera creates visible and separate monochrome IR images of a scene using one sensor array and having pixel to pixel alignment.

Another advantage of the hybrid camera described above is that car license plate images may be captured and the license plate number and license plate color may be acquired from the created visible and separate monochrome IR images.

Another advantage of the hybrid camera described above is that machine vision applications that use information acquired from the IR images to improve processing of visible images may take advantage of the pixel to pixel alignment of the two created images using one sensor array.

Another advantage of the hybrid camera described above is that other CFAs that have at least one pixel color appearing in all rows of the sensor array, similar to the green color pixel that appear in all rows in the Bayer pattern, may be included in the hybrid camera sensor array, and such CFAs are in the scope of the present invention.

Another advantage of the hybrid camera described above is that estimation schemes, such as linear interpolations, bi-linear interpolations, gradient base interpolations and high quality interpolations may be used to interpolate the captured raw data and are in the scope of the present invention

In summary, the hybrid camera of the present invention improves prior art image acquisition systems and methods by creating visible and separate monochrome IR images with pixel to pixel alignment using one sensor array.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description. While preferred embodiments of the present invention have been shown and described, it should be understood that various alternatives, substitutions, and equivalents can be used, and the present invention should only be limited by the claims and equivalents thereof.

What is claimed is:

1. A hybrid camera comprising:
(a) a sensor array comprising a color filter array that includes at least three colors wherein at least one color of said three colors appears at least once in each row of said color filter array;
(b) a rolling shutter configured to expose groups of pixels of said sensor array sequentially
(c) an IR illuminator configured to illuminate a scene alternately in synchrony with said rolling shutter and sensor array; and
(d) a control system configured to operate said sensor array, said rolling shutter and said IR illuminator,
wherein said control system is configured further to receive raw pixel data from said sensor array that include alternating visible data and visible plus IR data and to create from said raw pixel data a visible image of said scene and a separate monochrome IR image of said scene, wherein said control system is configured to create said monochrome IR image by subtraction of a first color image that includes the first color plus IR data pixels from a second image of said first color that includes the first color data only, and wherein said created monochrome IR image is subtracted from a second color image that includes visible and IR data to create a second color image, which is combined further with the first and third color images to create said visible image.

2. The hybrid camera of claim 1, wherein said created visible and separate monochrome IR images of said scene have pixel to pixel alignment.

3. The hybrid camera of claim 1, wherein said color filter array at least three colors are RGB.

4. The hybrid camera of claim 1, wherein said control system configured to create a visible image of said scene and an IR image of said scene is configured further to create multiple images from said groups of pixels of said array exposed in a sequence, and wherein one part of said created images includes visible and IR data and a second part of said created images includes visible data only.

5. The hybrid camera of claim 1, wherein said created visible image of said scene and said created IR image of said scene are created by subtracting said one part of said created images that include visible and IR data and said second part of said created images that include visible data only.

6. The hybrid camera of claim 1, wherein said multiple images are created by estimating pixels not captured from captured pixels.

7. The hybrid camera of claim 1, wherein said one part of said created images include a first visible color plus IR image and a second visible color plus IR image, and wherein said second part of said created images include said first visible color image and a third visible color image, and wherein said IR image is created by subtracting said first visible color image from said first visible color with IR image, and said color image is created by the first visible color, second visible color and third visible color images wherein said second visible color image is further calculated by subtracting said created IR image from said second visible color with IR image.

8. The hybrid camera of claim 1, wherein said rolling shutter configured to expose groups of pixels of said sensor array in a sequence and IR illuminator configured to illuminate the scene in synchrony with said exposed sequence is selected from the group consisting of:
(i) at least portions of odd rows are exposed sequentially to visible light only and at least portions of even rows are exposed to visible and IR illumination,
(ii) at least portions of even rows are exposed sequentially to visible light only and at least portions of odd rows are exposed to visible and IR illumination,
(iii) at least portions of odd columns are exposed sequentially to visible light only and at least portions of even columns are exposed to visible and IR illumination, and
(iv) at least portions of even columns are exposed sequentially to visible light only and at least portions of odd columns are exposed to visible and IR illumination.

9. The hybrid camera of claim 1, wherein said sensor array is a CMOS sensor array.

10. The hybrid camera of claim 1, wherein said IR illuminator is an array of LED's.

11. An image acquisition method, the method comprises the steps of:
(a) illuminating a scene with an IR illuminator alternately in a sequence and in synchrony with a rolling shutter and a sensor array, wherein said sensor array comprising a color filter array that include at least three colors, and wherein at least one color of said three colors appears at least once in each row of said color filter array;
(b) capturing said image in a sequence in groups of pixels that include visible data and visible plus IR data alternately using said sensor array;
(c) creating visible and separate monochrome IR images using said captured data and having pixel to pixel alignment, wherein said monochrome IR image is created by subtraction of a first color image that includes the first color plus IR data pixels from a second image of said first color that includes the first color data only, and wherein said created monochrome IR image is subtracted from a second color image that includes visible and IR data to create a second color image, which is combined further with the first and third color images to create said visible image.

12. The method of claim 11, wherein said step of capturing said image in a sequence in groups of pixels using said sensor array comprises further the step of using a RGB color filter.

13. The method of claim 11, wherein said step of creating visible and IR images of said scene comprises further creating multiple images from said captured groups of pixels, and wherein one part of said multiple created images includes visible and IR data and a second part of said multiple created images includes visible data only.

14. An automated number plate recognition image acquisition method according to claim 11, wherein said captured scenes are car license plates and wherein the method further comprises the steps of reading the car license number from said created monochrome IR image, identifying the color of said car license plate from said created visible color image and transmitting said created cars license plates visible and IR digital images having a pixel to pixel alignment to a computer

15. An image acquisition method for machine vision applications according to claim 11, wherein said method comprises further the step of using IR information acquired from said IR images for processing said created visible images.
